(19) United States
(12) Patent Application Publication
(10) Pub. No.: US 2010/0181094 A1
(43) Pub. Date: Jul. 22, 2010

(54) MAGNETIC WIRE WITH CORONA-RESISTANT COATING

(75) Inventor: Edgar Alberto Duarte Pena, Monterrey (MX)

Correspondence Address: MICHAEL WINFIELD GOLTRY, 4000 N. CENTRAL AVENUE, SUITE 1220, PHOENIX, AZ, 85012, US

(73) Assignee: MAGNEKON, S.A. DE C. V., San Nicolas de los Garza (NL)

(21) Appl. No.: 12/451,854

(22) PCT Filed: Apr. 13, 2007
(86) PCT No.: PCT/MX2007/000051

§ 371 Date: Dec. 3, 2009

(51) Int. Cl. H01B 7/18; B05D 5/12; H01B 1/12; H01B 7/17

(52) U.S. Cl. 174/120 C; 427/117; 427/118; 252/500; 252/519.33; 252/512; 174/110 SR

(57) ABSTRACT

A magnet wire formed by an electric conductor, and a corona-resistant coating disposed around electric conductor; the corona-resistant coating includes a quantity of polymeric resin having a dielectric strength of at least about 7874 V/mm (200 V/mil), and a quantity of conductive polymer having a conductivity in a range from about 1×10⁻¹³ S/cm (2.54×10⁻¹³ S/in) to about 1×10³ S/cm (2.54×10³ S/in).

### TECHNICAL FIELD OF THE INVENTION

The invention relates to electric conductors coated with wire enamel compositions, and more particularly to a magnet wire with a corona-resistant coating containing a conductive polymer compound.

### BACKGROUND OF THE INVENTION

Coated electric conductors typically comprise one or more electric insulation layers, also referred to as wire enamel compositions or coating composition, formed around a conductive core. Magnet wire is one form of coated electric conductor in which the conductive core is a copper wire, and the insulation layer or layers comprise dielectric materials, such as polymeric resins, coated peripherally around the copper wire. Magnet wire is used in the electromagnet windings of transformers, electric motors, and the like. Because of its use in such windings, the insulation system of magnet wire must be sufficiently flexible such that the insulation does not delaminate or crack or otherwise suffer damage during winding operations. The insulation system must also be sufficiently abrasion resistant so that the outer surface of the system can survive the friction, scraping and abrading forces that can be encountered during winding operations. The insulation system also must be sufficiently durable and resistive to degradation so that insulative properties are maintained over a long period of time.

The insulation layer or layers of coated conductors may fail as a result of the destructive effects caused by corona discharge. Corona discharge is a phenomenon particularly evident in high voltage environments (AC or DC), such as the electromagnet wire windings of electric motors and the like. Corona discharge occurs when conductors and dielectric materials, in the presence of a gas (usually air), are subjected to voltages above the corona starting voltage. Corona discharge ionizes oxygen contained in this gas to form ozone. The resultant ozone tends to attack the polymeric materials used to form conductor insulation layers, effectively resulting in polymer degradation and destroying the insulation characteristics of such insulation in the region of the attack. Accordingly, electrical conductors coated with polymeric insulation layers are desirably protected against the destructive effects of corona discharge.

Examples of current practices to provide improved insulation systems having corona resistance properties can be found in the following patents documents:

James J. McKeown, in U.S. Pat. No. 3,577,346, describes insulated electric conductors having improved corona resistance comprising a metal conductor surrounded by a major portion of a dielectric polymer containing intermixed therewith a minor amount of an organo-metallic compound of a metal selected from silicon, germanium, tin, lead, phosphorous, arsenic, antimony, bismuth, iron, ruthenium, and nickel, and a method for the preparation of the insulated electric conductors.

John J. Keane and Denis R. Pauze, in U.S. Pat. No. 4,537,804, describe a corona-resistant wire enamel composition comprising a polyimide, polyamide, polyester, polyamideimide, polyesterimide, or polyetherimide resin and from about 1% to about 35% by weight of dispersed alumina particles of a finite size less than about 0.1 micron, the alumina particles being dispersed therein by high shear mixing. A method of providing corona resistant one and two-stage insulations for an electrical conductor employing the above compositions and an electrical conductor insulated with a one or two-stage coating of the wire enamel compositions are also disclosed.

Don R. Johnston and Mark Markovitz, in U.S. Pat. No. 4,760,296, describe resinous compositions used as electric insulation have unique corona-resistance increased from 10 to 100 fold or more by the addition of organo-aluminate, organo-silicate or fine alumina or silica of critical particle size, and dynamoelectric machines and transformers incorporating coils made of wire strands coated with these novel compositions consequently have substantially increased service lives.

John E. Hake and David A. Metzler, in U.S. Pat. No. 5,917,155, describe an electric conductor coated with a corona-resistant, multilayer insulation system comprising first, second, and third insulation layers. The first insulation layer is disposed peripherally around the electrical conductor, the second layer is disposed peripherally around the first layer, and the third layer is disposed peripherally around the second layer. The second layer is sandwiched between the first and third layers and comprises 10 to 50 parts by weight of alumina particles dispersed in 100 parts by weight of a polymeric binder.

Thus, there is a continuing need for corona-resistant materials which are easily fabricated for use as electric insulation and a further need for additives which can convert dielectric materials susceptible to corona damage to corona-resistant materials. Accordingly, it is the principal object of the invention to provide a corona-resistant coating, useful in various electric insulation forms to satisfy these long-felt needs.

### SUMMARY OF THE INVENTION

The invention provides a magnet wire which comprises an electric conductor and a corona-resistant coating disposed around the electric conductor; the corona-resistant coating includes a quantity of polymeric resin having a dielectric strength of at least about 7874 V/mm (200 V/mil), and a quantity of conductive polymer having a conductivity in a range from about 1×10⁻¹³ S/cm (2.54×10⁻¹³ S/in) to about 1×10³ S/cm (2.54×10³ S/in).

In one aspect, the invention concerns an electric conductor coated with a corona-resistant coating constituted by alternating layers of polymeric resin and layers of conductive polymer.

In another aspect, the invention concerns an electric conductor coated with a corona-resistant coating constituted by an inner layer and an outer layer of polymeric resin, with an intermediate layer of conductive polymer.

In one aspect, the invention concerns an electric conductor coated with a corona-resistant coating constituted by a single layer constituted by a mixture of polymeric resin and conductive polymer.

The invention may also be embodied by a corona-resistant coating composition comprises a quantity of polymeric resin having a dielectric strength of at least about 7874 V/mm (200 V/mil), and a quantity of conductive polymer having a conductivity in a range from about 1×10⁻¹³ S/cm (2.54×10⁻¹³ S/in) to about 1×10³ S/cm (2.54×10³ S/in).

The invention may also be embodied by a method for coating an electric conductor, the method includes the steps of providing a corona-resistant coating composition which includes a quantity of polymeric resin having a dielectric strength of at least about 7874 V/mm (200 V/mil), and a quantity of conductive polymer having a conductivity in a range from about 1×10⁻¹³ S/cm (2.54×10⁻¹³ S/in) to about 1×10³ S/cm (2.54×10³ S/in), and coating the electric conductor.

Finally, the invention may be embodied by an electrical winding which comprises a winding magnet wire that includes an electric conductor, and a corona-resistant coating disposed around the electric conductor; the corona-resistant coating includes a quantity of polymeric resin having a dielectric strength of at least about 7874 V/mm (200 V/mil), and a quantity of conductive polymer having a conductivity in a range from about 1×10⁻¹³ S/cm (2.54×10⁻¹³ S/in) to about 1×10³ S/cm (2.54×10³ S/in).

### BRIEF DESCRIPTION OF THE FIGURES

The characteristic details of the invention are described in the following paragraphs, together with the attached figures that have the purpose to define the invention, but without limiting the scope of the latter.

FIG. 1 illustrates a section view of a first embodiment of a magnet wire according to the invention.

FIG. 2 illustrates a section view of a second embodiment of a magnet wire according to the invention.

FIG. 3 illustrates a section view of a third embodiment of a magnet wire according to the invention.

### DETAILED DESCRIPTION OF THE INVENTION

The following description is intended to be only representative of the manner in which the principles of the invention may be implemented in various actual embodiments. The embodiments disclosed below are not intended to be an exhaustive representation of the invention. Nor are the embodiments disclosed below intended to limit the invention to the precise form disclosed in the following detailed description.

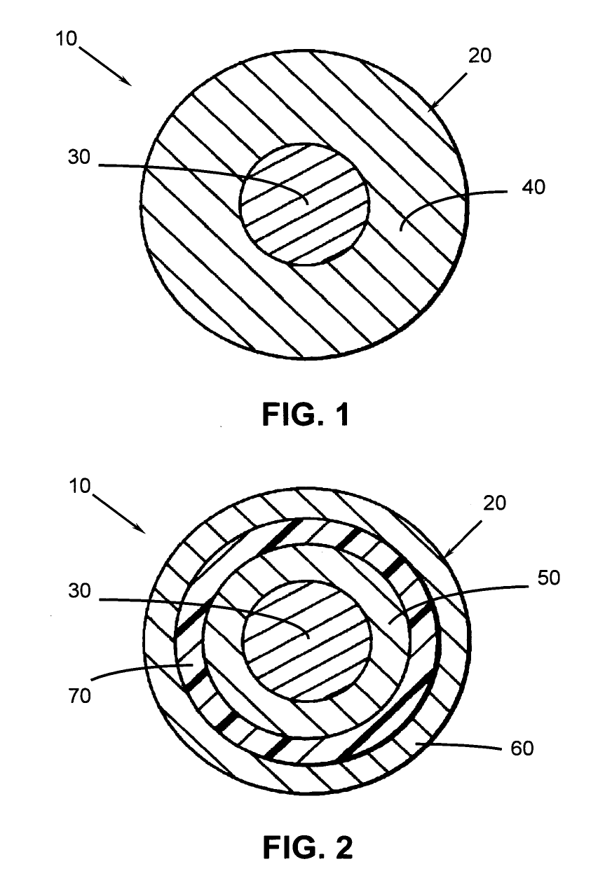

Referring now to FIGS. 1, 2, and 3, a magnet wire 10 is formed by a corona-resistant coating 20 coated around an electric conductor 30. The electric conductor 30 is generally a wire or a laminated conductor of any kind of conductive material, as desired. For example, the electric conductor 30 could be formed from cooper, copper clad aluminum, silver plated copper, nickel plated copper, gold plated cooper, aluminum alloy 1350, combinations thereof, or the like. The electric conductor 30 is produced to meet or exceed all the requirements from ANSI/NEMA MW1000 standard.

Corona-resistant coating 20 has electrical insulative, flexibility, and corona-resistant properties and thereof it serves as a electrically insulative material for the electric conductor 30. In all the specifics embodiments of the invention the corona-resistant coating 20 is protected against dielectric degradation provoked by pulsed voltage surge associated with variable frequency, PWM and/or inverted drives of AC motors. Therefore the magnet wire 10 of the invention having a base coat can be use in all the applications for a magnet wire as presented in the background of the invention. Additionally the corona-resistant coating 20 of the invention having at least one semi-conductive material mixed or superimposed on the base coat shows an extended life compared against conventional wire when subject to dielectric stresses experienced in environment of high frequency and voltage such as motors controlled inverter drives.

In the first embodiment shown in FIG. 1, the corona-resistant coating 20 includes a single layer 40 constituted by a mixture of polymeric resin as base coat and conductive polymer as semi-conductive material in a weight ratio of polymeric resin to conductive polymer in a range from 100:0.5 to 100:30, most particularly, from 100:2 to 100:20. The polymeric resin having a dielectric strength of at least about 7874 V/mm (200 V/mil) and the conductive polymer having a conductivity in a range from about 1×10⁻¹³ S/cm (2.54×10⁻¹³ S/in) to about 1×10³ S/cm (2.54×10³ S/in).

A variety of such polymeric resins are known in the art and include terephthalic acid alkyds, polyesters, polyesterimides, polyesteramides, polyesteramideimides, polyesterurethanes, polyurethanes, epoxy resins, polyamides, polyimides, polyamideimides, polysulphones, silicone resins, polymers incorporating polyhydantoin, phenolic resins, vinyl copolymers, polyolefins, polycarbonates, polyethers, polyetherimides, polyetheramides, polyetheramideimides, polyisocyanates, mixtures thereof, and the like. An example of a commercial product containing such a combination of polymeric resins is available from the P. D. George Company under the trade designation “TERESTER 966”.

The conductive polymer is a doped or non-doped conductive polymer selected from polyaniline, polypyrrole, polyacetilene, poly(sulfur nitride), N-phenyl P-phenylene diamine, polythiophene, polyarylthiophene, polyarylvinylene, poly (P-phenylene vinylene), poly(P-phenylene sulfide), poly(P-phenylene), paraphenylene vinylene, copolymers thereof, and mixtures thereof. In a particular embodiment, the conductive polymer is polyaniline at concentrations of about 10% to 20% by weight of corona-resistant coating composition, and preferably of about 10% to 13% by weight of corona-resistant coating composition. Examples of commercially products of polyaniline are available from Eeonyx Corporation under the trade designation “EEONOMER E” and from Panipol under the trade designation “PANIPOL PA”.

Doped conductive polymer is doped with doping species selected from p-type (oxidative) Br₂, ASF₅, I, SBF₆, H₂SO₄, HCl, (NO)(PF₆), Ag(ClO₄), n-type (reductive) K, Li, Na, and mixtures thereof.

Polymeric resin and conductive polymer are mixed with at least a common solvent selected from n-methylpyrrolidone, dimethylformamide, m-cresol, toluene, xylene, tetrahydrofuran, dimethyl sulfoxide, and mixtures thereof.

Incorporation of at least one conductive polymer into a base coat of polymeric resin to form a corona-resistant coating 20 greatly enhances the corona resistance of the magnet wire 10. The enhanced corona resistance is generally due to the relatively high conductive polymer content of the single layer 40.

Corona-resistant coating 20 is applied uniformly, continuously and concentric over the electric conductor 30 by any conventional appropriate means such as conventional solvent application, extrusion application or electrostatic deposition. More preferably, such corona-resistant coating 20 of a single layer is formed from one or more fluid thermoplastic or thermosetting polymeric resins mixed with at least one conductive polymer, the corona-resistant coating 20 is coated onto the electric conductor 30 and then dried and/or cured, as desired, using one or more suitable curing and/or drying techniques such as chemical, radiation, or thermal treatments.

Turning now to FIG. 2, a second embodiment of the magnet wire 10 of the invention is shown. The corona-resistant coating 20 is constituted by alternating layers of polymeric resin and layers of conductive polymer or layers of polymeric resin mixed with conductive polymer. In this embodiment, the electric conductor 30 is coated with a corona-resistant coating 20 which is constituted by an inner layer 50 and an outer layer 60 of polymeric resin, with an intermediate layer 70 of conductive polymer.

Although corona-resistant coating 20 is illustrated as comprising these three layers, more or less layers could be utilized depending upon which one or more aspects of the invention are to be incorporated into magnet wire 10.

Inner layer 50 is provided peripherally around electric conductor 30 and serves as an electrically insulative, flexible base coating for corona-resistant coating 20. Because of its electrically insulative properties, first inner layer 50 helps insulate electric conductor 30 when electric conductor 30 carries electrical current during electric device operations. Because of its flexibility characteristics, first inner layer 50 helps prevent intermediate layer 70 from cracking and/or delaminating when magnet wire 10 is wound into the windings of an electric device, such as an electrical motor, an electric generator, an electric transformer, an electric reactor, and an electric actuator. The intermediate layer 70 incorporates relatively large amounts of at least one conductive polymer. Flexible first inner layer 50, in cooperation with flexible third outer layer 60, effectively sandwich, and thus reinforce, intermediate layer 70 to thereby substantially reduce and even eliminate the tendency of intermediate layer 70 having a tendency to crack or delaminate during winding operations. Third, outer layer 60 also contributes to electrical and thermally insulative properties as well as to impact resistance, scrape resistance, and windability.

Inner layer 50 and outer layer 60 may be formed from any variety of such polymeric resins described above. While the intermediate layer 70 may be formed from any variety of such conductive polymers described above or a combination of at least one polymeric resin with at least one conductive polymer in a weight ratio of polymeric resin to conductive polymer in a range from 100:0.5 to 100:30, most particularly, from 100:2 to 100:20. The polymeric resin having a dielectric strength of at least about 7874 V/mm (200 V/mil) and the conductive polymer having a conductivity in a range from about 1×10⁻¹³ S/cm (2.54×10⁻¹³ S/in) to about 1×10³ S/cm (2.54×10³ S/in).

Incorporation of a intermediate layer 70 of conductive polymer between at least two layers of polymeric resin to form a corona-resistant coating 20 greatly enhances the corona resistance of magnet wire 10. The enhanced corona resistance is generally due to the relatively high conductive polymer content of intermediate layer 70.

The corona-resistant coating 20 may be formed upon electric conductor 30 using conventional coating processes well known in the art. Generally, homogeneous admixtures comprising the compounds of each layer 50, 60, and 70 dispersed in a suitable solvent (described above) are prepared and then coated onto the electric conductor 30 using multipass coating and wiping dies. The insulation build up is typically dried and cured in an oven after each pass.

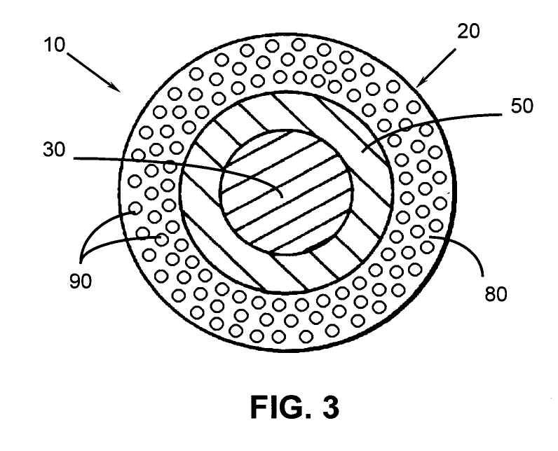

In FIG. 3, a third embodiment of the magnet wire 10 of the invention is shown. The corona-resistant coating 20 is constituted by alternating layers of polymeric resin and layers of conductive polymer or layers of polymeric resin mixed with conductive polymer. In this embodiment, the electric conductor 30 is coated with a corona-resistant coating 20 which is constituted by an inner layer 50 of polymeric resin, with an outer layer 80 of polymeric resin with conductive polymer particles as filler.

Although corona-resistant coating 20 is illustrated as comprising these two layers, more or less layers of polymeric resin with conductive polymer particles could be utilized depending upon which one or more aspects of the invention are to be incorporated into magnet wire 10.

Inner layer 50 is provided peripherally around electric conductor 30 and serves as an electrically insulative, flexible base coating for corona-resistant coating 20. Because of its electrically insulative properties, first inner layer 50 helps insulate electric conductor 30 when electric conductor 30 carries electrical current during electric device operations. Because of its flexibility characteristics, the inner layer 50 helps prevent outer layer 80 from cracking and/or delaminating when magnet wire 10 is wound into the windings of an electric device. The outer layer 80 incorporates relatively large amounts of conductive polymer particles into at least one polymeric resin.

Outer layer 80 comprises conductive polymer particles dispersed in at least one polymeric resin acting as binder. Outer layer 80 incorporates an amount of conductive polymer particles sufficient to provide magnet wire 10 with corona resistant characteristics. In the practice of the invention, a coated electric conductor such as magnet wire 10 is deemed to have corona resistance if, when subjected to one or more voltage pulses greater than the corona inception voltage, the time to failure by short circuit is at least fifty times more, preferably at least about 10 times, and more preferably at least about 100 times that of an unfilled coated electric conductor which is otherwise identical to the filled coated electric conductor.

In selecting an appropriate conductive polymer particles content to be used in outer layer 80, it is necessary to balance competing performance and practicality concerns. For example, if the conductive polymer particles content of outer layer 80 is too low, outer layer 80 may have insufficient corona resistance. On the other hand, if the conductive polymer particles content of outer layer 80 is too high, outer layer 80 may be too brittle such that outer layer 80 could crack or delaminate during winding operations. Using more conductive polymer particles than is needed to provide the desired degree of corona resistance may also unnecessarily increase the expense of fabricating magnet wire 10 and may also make it more difficult to manufacture outer layer 80. Generally, in the practice of the invention, incorporating 0.5 to 30, preferably 2 to 20, more preferably 10 to 20 parts by weight of conductive polymer particles into about 100 parts by weight of the polymeric resin binder would be suitable.

Incorporation of conductive polymer particles as a filler in a outer layer 80 into corona-resistant coating 20 greatly enhances the corona resistance of magnet wire 10. The enhanced corona resistance is generally due to the relatively high conductive polymer particles content of outer layer 80. In this embodiment, the inner layer 50 serves as an electrically insulative, flexible base coating, and the outer layer 80 incorporates conductive polymer particles 90 dispersed in at least one polymeric resin which acts as binder in order to provide corona resistive properties. The outer layer 80 also provides electrically insulative properties. The conductive polymer particles 90 give semi-conductivity properties to the outer layer 80. Therefore, the semi-conductive outer layer 80 is able to diffuse local electrical charge concentration, and thus form a protective shield around inner layer 50. Because of this protective barrier corona erosion is prevented from attacking inner layer 50. As a result, the insulative properties of inner layer 50 and outer layer 80 are preserved.

In the practice of the invention, it is generally desirable to use conductive polymer particles having a mean particle size as small as is practically possible, because smaller particles have a larger surface area which reduces electrical distances within the material and consequently dissipate more energy within the insulation and thereby form a better protective barrier, compared to the use of larger particles. Generally, conductive polymer particles having a surface area in a range from about 5 m²/g (210.7 ft²/lb) to about 800 m²/g (33,712 ft²/lb), would be suitable in the practice of the invention. In an alternative embodiment, conductive polymer particles can be deposited over particulated materials having a surface area in a range from about 5 m²/g (210.7 ft²/lb) to about 800 m²/g (33,712 ft²/lb) such as carbon black, alumina, titanium dioxide, silica, zirconium oxide, zinc oxide, iron oxide, chromium dioxide and combinations thereof, or the like.

The corona-resistant coating 20 may be formed upon electric conductor 30 using conventional coating processes well known in the art. Generally, homogeneous admixtures comprising the compounds of each layer 50 and 80 dispersed in a suitable solvent (described above) are prepared and then coated onto the electric conductor 30 using multipass coating and wiping dies. The insulation build up is typically dried and cured in an oven after each pass.

It is important to consider that the corona-resistant coating material can be manufactured by means of shear mixing, melting, high energy dispersion, ultrasound dispersion, the use of chemicals known of dispersants, the use of one or various solvents either in the same blend or in a sequential manner, the use of concentrated dispersions known as masterbatches, combinations of these techniques and any other mixing method that effectively disperses the conductive polymer into the polymeric resin.

In an alternative embodiment, a primer coat can be applied between the electric conductor and the corona-resistant coating in order to improve the adhesion of the corona-resistant coating. The primer coat may be formed from any variety of polymeric resins such as polyvinyl acetal, epoxy resins, and mixtures thereof.

In another alternative embodiment, the magnet wire may be include a bond coat disposed around the corona-resistant coating in order to bond turns of wire in a winding. The bond coat may be formed from any variety of thermo-adherent resins such as polyamide, polyester, epoxy adhesive, polyvinyl butyral, and mixtures thereof.

In an alternative embodiment, the corona-resistant coating may be incorporate a flexibility promoting agent in order to improve its flexibility. The flexibility promoting agent may be a polymeric resin such as polyglycolurea or the like.

In another alternative embodiment, a sliding promoting agent may be incorporated in the corona-resistant coating in order to improve the sliding properties of the magnet wire. The sliding promoting agent may be fluorinated organic resin such as polyvinyl fluoride, tetrafluoroethylene-perfluoroalkyvinylethylene copolymer, tetrafluoroethylene-hexafluoropropylene-perfluoro-alkyl-vinyl ether copolymer, tetrafluoroethylene-perfluoroalkylvinylether copolymer, tetrafluoroethylene-ethylene copolymer, polytetrafluoroethylene, polyvinylidene fluoride, chlorotrifluoroethylene-ethylene copolymer, polychloro-trifluoroethylene, and mixtures thereof. Alternatively the sliding promoting agent may be a wax such as carnauba, montan wax, and mixtures thereof.

In another alternative embodiment, an anti-wear agent may be incorporated in the corona-resistant coating in order to improve the wear resistance of the magnet wire. The anti-wear agent may be ceramic particles with a Knopp hardness of at least 1000, such ceramic particles may be carbides, nitrides, oxides, borides, and mixtures thereof.

In another alternative embodiment, a colorant agent may be incorporated in the corona-resistant coating in order to assess the quality coverage of the insulation and/or to help to identify the magnet wire during winding operations. The colorant agent may be a metallic oxide such as titanium dioxide, chromium dioxide, and mixtures thereof.

The invention will now be described with respect to the following examples. The following examples are intended to be only representative of the manner in which the principles of the invention may be implemented in actual embodiments. The following examples are not intended to be an exhaustive representation of the invention. Nor are the following examples intended to limit the invention only to the precise forms which are exemplified.

### EXAMPLES

### Control Magnet Wire A

An 18 gage conventional round copper magnet wire meeting or exceeding all the requirements from ANSI/NEMA MW1000 MW35 and/or MW 73 heavy build standard is produced to serve as control for reference in the invention. The wire is concentrically and continuously coated using a conventional magnet wire coating machine with a base coat of a conventional polyesterimide enamel comprising 38% weight resin in a solvent system of commercially available cresol, phenol and aromatic hydrocarbon. In this manner the increase in diameter due the base coat is approximately 0.05842 mm (0.0023 in). An outer coat of conventional polyamideimide enamel comprising 30% weight resin in a solvent system of commercially available N-methylpyrrolidone, dimethylformamide, and aromatic hydrocarbon is applied to the base coat adding 0.0127 mm (0.0005 in) in diameter increase. Properties for this wire are shown in Tables I, II and III.

### Example I

### An Embodiment of the Invention

An 18 gage round copper electric conductor meeting or exceeding all the requirements from ANSI/NEMA MW1000 MW35 and/or MW 73 heavy build standard is concentrically coated using a conventional magnet wire coating machine with a base coat (inner layer) of a commercially available THEIC modified polyester insulation from P. D. George under trade designation “TERESTER 966”. In this manner the increase in diameter due the base coat (inner layer) is approximately 0.04064 mm (0.0016 in).

2.84 kg (6.26 lb) of semi conductive polyaniline with a conductivity of approximately 1×10⁻⁹ S/cm (2.54×10⁻⁹ S/in) are added to 19 kg (41.88 lb) of a conventional polyesterimide enamel comprising 38% weight resin in a solvent system of commercially available cresol, phenol and aromatic hydrocarbon. The polyaniline is dispersed in the polyesterimide enamel by means of high shear mixing using a ball mill. The resulting semi-conductive enamel is concentrically and continuously applied to base coat (inner layer) forming a protective barrier, or shield layer (intermediate layer), around inner layer, in this manner the increase in diameter due the shield layer (intermediate layer) is approximately 0.02286 mm (0.0009 in).

An outer layer is then concentrically and continuously applied to the shield layer (intermediate layer) in order to provide mechanical protection as well as a sliding surface to the wire. The outer layer is a conventional polyamideimide enamel comprising 30% weight resin in a solvent system of commercially available N-methylpyrrolidone, dimethylformamide and aromatic hydrocarbon, and a sliding agent is within this enamel. The increase in diameter due the outer layer is approximately 0.01016 mm (0.0004 in). Properties for this wire are shown in Tables I, II and III.

### Example II

### An Embodiment of the Invention

An 18 gage round copper electric conductor meeting or exceeding all the requirements from ANSI/NEMA MW1000 MW35 and/or MW 73 heavy build standard is concentrically and continuously coated using a conventional magnet wire coating machine with a base coat (inner layer) of a commercially available THEIC modified polyester insulation from P. D. George under trade designation “TERESTER 966”. In this manner the increase in diameter due the base coat (inner layer) is approximately 0.04318 mm (0.0017 in).

590 g (1.30 lb) of conductive polyaniline deposited over a carbon black matrix with a conductivity of approximately 20 S/cm (50.8 S/in) and a surface area of approximately 200 m²/g (8428 ft²/lb) are added to 19 kg (41.88 lb) of a conventional polyesterimide enamel comprising 38% weight resin in a solvent system comprising commercially available cresol, phenol and aromatic hydrocarbon. The conductive polyaniline deposited over a carbon black matrix is dispersed in the polyesterimide enamel by means of high shear mixing using a ball mill. The resulting semi conductive enamel is concentrically and continuously applied to base coat (inner layer) forming a protective barrier, or shield layer (intermediate layer), around inner layer, in this manner the increase in diameter due the shield layer (intermediate layer) is approximately 0.02286 mm (0.0009 in).

An outer layer is then concentrically and continuously applied to the shield layer (intermediate layer) in order to provide mechanical protection as well as a sliding surface to the wire. The outer layer is a conventional polyamideimide enamel comprising 30% weight resin in a solvent system of commercially available N-methylpyrrolidone, dimethylformamide and aromatic hydrocarbon, and a sliding agent within this enamel. The increase in diameter due the outer layer is approximately 0.01016 mm (0.0004 in). Properties for this wire are shown in Tables I, II and III.

All the above magnet wires are electrically stressed applying a voltage with a closely square wave form, a duty cycle of 50%, a magnitude of +/−1,000V, a rise time of 2 microseconds and a frequency of 20 kHz. The magnet wire is thermally stressed in a forced convention oven at a temperature of 160° C. (320° F.), with a pre-heating period of 14 hours at 140° C. (284° F.). A total of sixteen standard twisted wire pair for each example are tested under in the above mentioned conditions until electrical failure occurs. Time to fail in seconds for the resulting wire is shown in Table I, mean time to failure (MTTF) computed assuming a Weibull distribution as well as 95% confidence intervals for it are shown in Table II.

It can be seen that the improved magnet wire of this invention meet or exceed all the requirements from ANSI/NEMA MW1000. The improved magnet wire of this invention can also withstand the electrical and thermal stresses similar of those occurring when using AC electric devices having variable frequency of PWM and/or inverter drives. Therefore the improved magnet wire of this invention can be use by electric devices makers to produce windings for electric devices that will operate under corona discharge conditions.

TABLE I

| Magnet Wire | |
|---|---|
| Example | Time to fail in seconds |
| Control Wire A | 2223, 2058, 2121, 1800, 2439, 2124, 1731, 2778, |
| | 1719, 2127, 1992, 1977, 1611, 1758, 2085, 1662 |
| Example I | 5553, 5124, 4125, 4635, 4479, 5526, 3840, 6315, |
| | 4893, 4479, 3144, 2676, 4641, 5766, 4386, 5532 |
| Example II | 3426, 2295, 3117, 2697, 2586, 3273, 2022, 4689, |
| | 3168, 3264, 2691, 3978, 3894, 3333, 2811, 3294 |

TABLE II

| | 95% Confidence interval | | | |
|---|---|---|---|---|
| Magnet Wire | MTTF | Lower | Upper | Correlation |
| Example | Estimate (s) | Limit (s) | Limit (s) | coefficient |
| Control Wire A | 2004.82 | 1867.53 | 2152.20 | 0.933 |
| Example I | 4686.34 | 4210.3 | 5216.22 | 0.987 |
| Example II | 3147.65 | 2842.66 | 3485.36 | 0.977 |

TABLE III

| | Magnet Wire Example | | | | | |
|---|---|---|---|---|---|---|
| | Control Wire A | | Example I | | Example II | |
| Electric conductor | Copper | | Copper | | Copper | |
| Size (AWG) | 18 | | 18 | | 18 | |
| Conductor diameter | 1.016-1.01854 | mm | 1.01854-1.02108 | mm | 1.016-1.02108 | mm |
| | (0.040-0.0401 | in) | (0.0401-0.0402 | in) | (0.040-0.0402 | in) |

| Overall diameter | | 0.0427-0.043 | 0.043-0.0432 | 0.043-0.04315 |
|---|---|---|---|---|
| Insulation build | | 0.0028 | 0.0029 | 0.003 |
| Breakdown Voltage | | 13053 | 9856 | 8308 |
| (V) avg. 5 tests | | | | |
| Adherence and | 1 d | OK | OK | OK |
| Flexibility 20% | 2 d | OK | OK | OK |
| elongation, | 3 d | OK | OK | OK |
| mandrel diameter | | | | |
| Springback (°) | | 54 | 48 | 48 |
| Heat shock 30 | 1 d | OK | OK | OK |
| min at 220° C. | 2 d | Ok | OK | OK |
| (428° F.), 20% | 3 d | OK | OK | OK |
| elongation, | | | | |
| mandrel diameter | | | | |

| | | | | | | |
|---|---|---|---|---|---|---|
| Thermoplastic flow | 456.6° | C. | 417° | C. | 369.2° | C. |
| avg. 5 tests. | (853.88° | F.) | (782.6° | F.) | (696.56° | F.) |

| | | | |
|---|---|---|---|
| Repeated scrape | 290 | 297 | 172 |
| (cycles) avg. 3 tests | | | |

Although the invention has been described with reference to specific embodiments, this description is not meant to be constructed in a limited sense. The various modifications of the disclosed embodiments, as well as alternative embodiments of the invention, will become apparent to persons skilled in the art upon reference to the description of the invention. It is, therefore, contemplated that the appended claims will cover such modifications that fall within the scope of the invention, or their equivalents.

1. A magnet wire comprising:
an electric conductor; and
a corona-resistant coating disposed around said electric conductor, wherein said corona-resistant coating including:
a quantity of polymeric resin having a dielectric strength of at least about 7874 V/mm (200 V/mil); and
a quantity of conductive polymer having a conductivity in a range from about 1×10⁻¹³ S/cm (2.54×10⁻¹³ S/in) to about 1×10³ S/cm (2.54×10³ S/in).

2. (canceled)

3. (canceled)

4. (canceled)

5. (canceled)

6. (canceled)

7. The magnet wire of claim 1, wherein said quantity of conductive polymer is in form of particles having a surface area in a range from about 5 m²/g (210.7 ft²/lb) to about 800 m²/g (33,712 ft²/lb).

8. The magnet wire of claim 1, further said conductive polymer is deposited over a particulated material having a surface area in a range from about 5 m²/g (210.7 ft²/lb) to about 800 m²/g (33,712 ft²/lb), wherein said particulated material selected from a group consisting of carbon black, alumina, titanium dioxide, silica, zirconium dioxide, zinc oxide, iron oxide, chromium dioxide, and mixtures thereof.

9. The magnet wire of claim 1, wherein the weight ratio of said quantity of polymeric resin to said quantity of conductive polymer is in a range from about 100:0.5 to about 100:30.

10. (canceled)

11. The magnet wire of claim 1, wherein said polymeric resin is selected from a group consisting of terephthalic acid alkyds, polyesters, polyesterimides, polyesteramides, polyesteramideimides, polyesterurethanes, polyurethanes, epoxy resins, polyamides, polyimides, polyamideimides, polysulphones, silicone resins, polymers incorporating polyhydantoin, phenolic resins, vinyl copolymers, polyolefins, polycarbonates, polyethers, polyetherimides, polyetheramides, polyetheramideimides, polyisocyanates, and mixtures thereof.

12. The magnet wire of claim 1, wherein said conductive polymer is a doped or non-doped conductive polymer selected from a group consisting of polyaniline, polypyrole, polyacetilene, poly(sulfur nitride), N-phenyl P-phenylene diamine, polythiophene, polyarylthiophene, polyarylvinylene, poly (P-phenylene vinylene), poly(P-phenylene sulfide), poly(P-phenylene), paraphenylene vinylene, copolymers thereof, and mixtures thereof.

13. The magnet wire of claim 12, wherein said doped conductive polymer is doped with doping species selected from a group consisting of p-type (oxidative) Br₂, ASF₅, I, SBF₆, H₂SO₄, HCl, (NO) (PF₆), Ag (ClO₄), n-type (reductive) K, Li, Na, and mixtures thereof.

14. The magnet wire of claim 1, further comprising said quantity of polymeric resin and said quantity of conductive polymer disposed in a quantity of solvent, and said solvent is selected from a group consisting of n-methylpyrrolidone, dimethylformamide, m-cresol, toluene, xylene, tetrahydrofuran, dimethyl sulfoxide, and mixtures thereof.

15. (canceled)

16. The magnet wire of claim 1, further comprising a primer coat between said electric conductor and said corona-resistant coating, and said primer coat comprises a quantity of polymeric resin selected from a group consisting of polyvinyl acetal, epoxy resins, and mixtures thereof.

17. (canceled)

18. The magnet wire of claim 1, further comprising a bond coat disposed around said corona-resistant coating, and said bond coat comprises a quantity of thermo-adherent resin selected from a group consisting of polyamide, polyester, epoxy adhesive, polyvinyl butyral, and mixtures thereof.

19. (canceled)

20. (canceled)

21. (canceled)

22. The magnet wire of claim 1, further said corona-resistant coating comprising a quantity of sliding promoting agent, and said sliding promoting agent is selected from a group consisting of polyvinyl fluoride, tetrafluoroethylene-perfluoroalkyvinylethylene copolymer, tetrafluoroethylene-hexafluoropropylene-perfluoro-alkyl-vinyl ether copolymer, tetrafluoroethylene-perfluoroalkylvinylether copolymer, tetrafluoroethylene-ethylene copolymer, polytetrafluoroethylene, polyvinylidene fluoride, chlorotrifluoroethylene-ethylene copolymer, polychloro-trifluoroethylene, carnauba, montan wax, and mixtures thereof.

23. (canceled)

24. The magnet wire of claim 1, further said corona-resistant coating comprising a quantity of anti-wear agent, and said anti-wear agent is at least a ceramic particle with a Knopp hardness of at least 1000, wherein said ceramic particle is selected from a group consisting of carbides, nitrides, oxides, borides, and mixtures thereof.

25. (canceled)

26. (canceled)

27. (canceled)

28. A corona-resistant coating composition comprising:
a quantity of polymeric resin having a dielectric strength of at least about 7874 V/mm (200 V/mil); and
a quantity of conductive polymer having a conductivity in a range from about 1×10⁻¹³ S/cm (2.54×10⁻¹³ S/in) to about 1×10³ S/cm (2.54×10³ S/in).

29. The corona-resistant coating composition of claim 28, wherein said quantity of conductive polymer is in form of particles having a surface area in a range from about 5 m²/g (210.7 ft²/lb) to about 800 m²/g (33,712 ft²/lb).

30. The corona-resistant coating composition of claim 28, wherein the weight ratio of said quantity of polymeric resin to said quantity of conductive polymer is in a range from about 100:0.5 to about 100:30.

31. (canceled)

32. The corona-resistant coating composition of claim 28, wherein said polymeric resin is selected from a group consisting of terephthalic acid alkyds, polyesters, polyesterimides, polyesteramides, polyesteramideimides, polyesterurethanes, polyurethanes, epoxy resins, polyamides, polyimides, polyamideimides, polysulphones, silicone resins, polymers incorporating polyhydantoin, phenolic resins, vinyl copolymers, polyolefins, polycarbonates, polyethers, polyetherimides, polyetheramides, polyetheramideimides, polyisocyanates, and mixtures thereof.

33. The corona-resistant coating composition of claim 28, wherein said conductive polymer is a doped or non-doped conductive polymer selected from a group consisting of polyaniline, polypyrole, polyacetilene, poly(sulfur nitride), N-phenyl P-phenylene diamine, polythiophene, polyarylthiophene, polyarylvinylene, poly (P-phenylene vinylene), poly(P-phenylene sulfide), poly(P-phenylene), paraphenylene vinylene, copolymers thereof, and mixtures thereof.

34. The corona-resistant coating composition of claim 33, wherein said doped conductive polymer is doped with doping species selected from a group consisting of p-type (oxidative) Br₂, ASF₅, I, SBF₆, H₂SO₄, HCl, (NO) (PF₆), Ag(ClO₄), n-type (reductive) K, Li, Na, and mixtures thereof.

35. The corona-resistant coating composition of claim 28, further comprising the quantity of polymeric resin and the quantity of conductive polymer disposed in a quantity of solvent, and said solvent is selected from a group consisting of n-methylpyrrolidone, dimethylformamide, m-cresol, toluene, xylene, tetrahydrofuran, dimethyl sulfoxide, and mixtures thereof.

36. (canceled)

37. (canceled)

38. (canceled)

39. The corona-resistant coating composition of claim 28, further comprising a quantity of sliding promoting agent, and said sliding promoting agent is selected from a group consisting of polyvinyl fluoride, tetrafluoroethylene-perfluoroalkyvinylethylene copolymer, tetrafluoroethylene-hexafluoropropylene-perfluoro-alkyl-vinyl ether copolymer, tetrafluoroethylene-perfluoroalkylvinylether copolymer, tetrafluoroethylene-ethylene copolymer, polytetrafluoroethylene, polyvinylidene fluoride, chlorotrifluoroethylene-ethylene copolymer, polychloro-trifluoroethylene, carnauba, montan wax, and mixtures thereof.

40. (canceled)

41. The corona-resistant coating composition of claim 28, further comprising a quantity of anti-wear agent, and said anti-wear agent is at least a ceramic particle with a Knopp hardness of at least 1000, wherein said ceramic particle is selected from a group consisting of carbides, nitrides, oxides, borides, and mixtures thereof.

42. (canceled)

43. (canceled)

44. (canceled)

45. The corona-resistant coating composition of claim 28, wherein said composition is manufactured by at least a mixing technique selected form a group consisting of shear mixing, melting, high energy dispersion, ultrasound dispersion, use of chemicals known of dispersants, use of one or various solvents either in the same blend or in a sequential manner, use of masterbatches, and combinations thereof.

46. A method for coating an electric conductor, said method comprising the steps of:
providing a corona-resistant coating composition comprising a quantity of polymeric resin having a dielectric strength of at least about 7874 V/mm (200 V/mil), and a quantity of conductive polymer having a conductivity in a range from about 1×10⁻¹³ S/cm (2.54×10⁻¹³ S/in) to about 1×10³ S/cm (2.54×10³ S/in); and
coating said electric conductor with said corona-resistant coating composition.

47. (canceled)

48. (canceled)

49. (canceled)

50. (canceled)

51. (canceled)

52. The method of claim 46, wherein said quantity of conductive polymer is in form of particles having a surface area in a range from about 5 m²/g (210.7 ft²/lb) to about 800 m²/g (33,712 ft²/lb).

53. The method of claim 46, wherein the weight ratio of said quantity of polymeric resin to said quantity of conductive polymer is in a range from about 100:0.5 to about 100:30.

54. (canceled)

55. The method of claim 46, wherein said polymeric resin is selected from a group consisting of terephthalic acid alkyds, polyesters, polyesterimides, polyesteramides, polyesteramideimides, polyesterurethanes, polyurethanes, epoxy resins, polyamides, polyimides, polyamideimides, polysulphones, silicone resins, polymers incorporating polyhydantoin, phenolic resins, vinyl copolymers, polyolefins, polycarbonates, polyethers, polyetherimides, polyetheramides, polyetheramideimides, polyisocyanates, and mixtures thereof.

56. The method of claim 46, wherein said conductive polymer is a doped or non-doped conductive polymer selected from a group consisting of polyaniline, polypyrole, polyacetilene, poly(sulfur nitride), N-phenyl P-phenylene diamine, polythiophene, polyarylthiophene, polyarylvinylene, poly (P-phenylene vinylene), poly(P-phenylene sulfide), poly(P-phenylene), paraphenylene vinylene, copolymers thereof, and mixtures thereof.

57. The method of claim 56, wherein said doped conductive polymer is doped with doping species selected from a group consisting of p-type (oxidative) Br₂, ASF₅, I, SBF₆, H₂SO₄, HCl, (NO) (PF₆), Ag(ClO₄), n-type (reductive) K, Li, Na, and mixtures thereof.

58. The method of claim 46, further comprising the quantity of polymeric resin and the quantity of conductive polymer disposed in a quantity of solvent, and said solvent is selected from a group consisting of n-methylpyrrolidone, dimethylformamide, m-cresol, toluene, xylene, tetrahydrofuran, dimethyl sulfoxide, and mixtures thereof.

59. (canceled)

60. The method of claim 46, further comprising the step of coating a primer coat between said electric conductor and said corona-resistant coating, and said primer coat comprises a quantity of polymeric resin selected from a group consisting of polyvinyl acetal, epoxy resins, and mixtures thereof.

61. (canceled)

62. The method of claim 46, further comprising the step of coating a bond coat around said corona-resistant coating, and said bond coat comprises a quantity of thermo-adherent resin selected from a group consisting of polyamide, polyester, epoxy adhesive, polyvinyl butyral, and mixtures thereof.

63. (canceled)

64. (canceled)

65. (canceled)

66. The method of claim 46, further said corona-resistant coating comprising a quantity of sliding promoting agent, and said sliding promoting agent is selected from a group consisting of polyvinyl fluoride, tetrafluoroethylene-perfluoroalkyvinylethylene copolymer, tetrafluoroethylene-hexafluoropropylene-perfluoro-alkyl-vinyl ether copolymer, tetrafluoroethylene-perfluoroalkylvinylether copolymer, tetrafluoroethylene-ethylene copolymer, polytetrafluoroethylene, polyvinylidene fluoride, chlorotrifluoroethylene-ethylene copolymer, polychloro-trifluoroethylene, carnauba, montan wax, and mixtures thereof.

67. (canceled)

68. The method of claim 46, further said corona-resistant coating comprising a quantity of anti-wear agent, and said anti-wear agent is at least a ceramic particle with a Knopp hardness of at least 1000, wherein said ceramic particle is selected from a group consisting of carbides, nitrides, oxides, borides, and mixtures thereof.

69. (canceled)

70. (canceled)

71. (canceled)

72. (canceled)

73. (canceled)
